(19) United States
(12) Patent Application Publication
(10) Pub. No.: US 2020/0202426 A1
(43) Pub. Date: Jun. 25, 2020

(54) SYSTEM AND METHOD FOR GENERATING COMPUTERIZED EDUCATIONAL TOOL

(71) Applicant: DIVERSIFY FINANCE LIMITED, Toronto (CA)

(72) Inventor: Jennifer Anne FAGG, Toronto (CA)

(21) Appl. No.: 16/609,889

(22) PCT Filed: Jan. 16, 2018
(86) PCT No.: PCT/IB2018/050261

§ 371 Date: Oct. 31, 2019

Related U.S. Application Data
(60) Provisional application No. 62/492,543, filed on May 1, 2017.

(51) Int. Cl. G06Q 40/02; G09B 19/00; G06N 5/04

(52) U.S. Cl. CPC G06Q 40/025; G06N 5/04; G09B 19/00

(57) ABSTRACT

A system and method for generating a computerized educational tool displayed on a graphical user interface. The system includes an assessment device which maps input data relating to the probability that a transaction between a provider and a recipient may fail onto the cells of a decision table. Mapping to the cells of the decision table includes non-linear algorithms. The decision table can be used to inform structuring and restructuring of the transaction. The decision table can be outputted to a display on the assessment device, or transmitted over a network to a provider device, a recipient device, or both.

### CROSS-REFERENCE TO RELATED APPLICATIONS

This application claims priority to U.S. 62/492,543, filed May 1, 2017, the entirety of which is incorporated herein by reference.

### FIELD

The present disclosure relates to computerized educational tools, and in particular, to systems and methods for generating a computerized educational tool displayed on a graphical user interface.

### BACKGROUND

Computers can be configured to make decisions for various purposes by running input variables through decision-making algorithms. For example, a computer can be configured to determine an appropriate advertisement to display to a user at a particular instance, based on several variables extracted from the user's online activity history, and the predicted likelihood that the user will click the displayed advertisement. A computer's processing and data-storage power can be leveraged to execute a complicated calculation incorporating vast amounts of data to make a complex decision in a short period of time. However, such calculations are computationally-intensive, especially when repeatedly executed when re-making decisions.

A human being is not capable of the processing or data-storage capabilities of a computer, but may be aided in decision-making by using educational tools. One of such educational tools is a decision-making matrix. A typical decision-making matrix may include a two-dimensional array of cells, each dimension corresponding to a particular criterion relevant to making a decision, and each cell conveying an option for a decision and/or outcome corresponding to the scenario set out by the criteria corresponding to the coordinate of the cell. Although a decision-making matrix may serve as a useful visual aid, it may be generated in a manner which oversimplifies the decision-making process, and which mislead the user's understanding of the context of the greater decision-making space.

### SUMMARY

According to an aspect of the disclosure, a graphical user interface system is provided. The system includes a provider user interface, a recipient user interface, a memory for storing programming instructions, and a processor in communication with the memory and configured to execute the programming instructions to generate a decision table comprising an ordered two-dimensional array of cells, the decision table having a first dimension corresponding to provider transaction failure probability and a second dimension corresponding to recipient transaction failure probability, a cell providing indications of provider transaction failure probability and recipient transaction failure probability corresponding to a coordinate of the cell in the two dimensions, receive provider transaction failure probability data from the provider user interface and recipient transaction failure probability data from the recipient user interface, map transaction failure probability criteria to the cells of the decision table according to a qualitative algorithm, map the provider transaction failure probability data, and the recipient transaction failure probability data to the decision table to indicate a cell of the decision table corresponding to the provider transaction failure probability data and the recipient transaction failure probability data, and generate a graphical user interface displaying the decision table for output at the provider user interface, the recipient user interface, or both the provider user interface and the recipient user interface.

The qualitative algorithm may involve weighing a portion of the provider transaction failure probability data or the recipient transaction failure probability data differently according to a non-linear relationship between provider transaction failure probability and recipient transaction failure probability.

The processor may be further configured to execute the programming instructions to receive preliminary provider data and preliminary recipient data, maintain a provider question library comprising questions relating to the provider transaction failure probability data, and maintain a recipient question library comprising questions relating to the recipient transaction failure probability data, and generate a selection of provider questions from the provider question library based on the preliminary provider data, the preliminary recipient data, or both the preliminary provider data and the preliminary recipient data, output the selection of provider questions and receive responses to the selection of provider questions via the provider user interface, the provider transaction failure probability data corresponding to the responses to the selection of provider questions, generate a selection of recipient questions from the recipient question library based on the preliminary provider data, the preliminary recipient data, or both the preliminary provider data and the preliminary recipient data, and output the selection of recipient questions and receive responses to the selection of recipient questions via the recipient user interface, the recipient transaction failure probability data corresponding to the responses to the selection of recipient questions.

The qualitative algorithm may involve weighing a response of the responses to the selection of provider questions or the responses to the selection of recipient questions differently based on another response of the responses to the selection of provider questions or the responses to the selection of recipient questions.

The processor may be further configured to execute the programming instructions to modify the selection of provider questions or the selection of recipient questions according to a response to the selection of provider questions or the selection of recipient questions.

An indication of provider transaction failure probability or recipient transaction failure probability may include a written description response to a question of the selection of provider questions or the selection of recipient questions.

An indication of provider transaction failure probability or recipient transaction failure probability, or both, may include a graphical illustration.

The system may further include a computer network, a network interface in communication with the processor, and a transaction mediator device in communication with the network interface via the computer network, the transaction mediator device being configured to facilitate a transaction based on at least the provider transaction failure probability data and the recipient transaction failure probability data.

The system may further include a computer network, a network interface in communication with the processor, and a supplementary information provider device in communication with the network interface via the computer network to provide supplementary data for inclusion in the provider transaction failure probability data or the recipient transaction failure probability data.

The system may further include an assessment device having the memory and the processor, and the assessment device is configured to display the provider user interface, the recipient user interface, and the graphical user interface displaying the decision table.

The system may further include a computer network, a network interface in communication with the processor, a provider device and a recipient device both in communication with the network interface via the computer network, the provider device configured to display the provider user interface, the recipient device configured to display the recipient user interface.

According to another aspect of the disclosure, a method for generating a graphical user interface displaying a decision table is provided. The method includes generating a decision table comprising an ordered two-dimensional array of cells, the decision table having a first dimension corresponding to provider transaction failure probability and a second dimension corresponding to recipient transaction failure probability, a cell providing indications of provider transaction failure probability and recipient transaction failure probability corresponding to a coordinate of the cell in the two dimensions, receiving provider transaction failure probability data from a provider user interface and recipient transaction failure probability data from a recipient user interface, mapping transaction failure probability criteria to the cells of the decision table according to a qualitative algorithm, mapping the provider transaction failure probability data, and the recipient transaction failure probability data to the decision table to indicate a cell of the decision table corresponding to the provider transaction failure probability data and the recipient transaction failure probability data, and generating a graphical user interface displaying the decision table for output at the provider user interface, the recipient user interface, or both the provider user interface and the recipient user interface.

The method may involve monitoring transaction failure probability, updating provider transaction failure probability or recipient transaction failure probability, and determining a revised coordinate corresponding to updated provider transaction failure probability or recipient transaction failure probability.

The method may involve examining an indication of provider transaction failure probability and recipient transaction failure probability of cell adjacent to the cell corresponding to the provider transaction failure probability data and the recipient transaction failure probability data, revising provider transaction failure probability or recipient transaction failure probability, and determining a revised coordinate corresponding to revised provider transaction failure probability or recipient transaction failure probability.

### BRIEF DESCRIPTION OF THE DRAWINGS

Embodiments of the present disclosure will now be described, by way of example only, with reference to the attached Figures, wherein:

FIG. 1 is a schematic diagram of a system for generating a computerized educational tool, according to a non-limiting embodiment;

FIG. 2 is a block diagram of functional components of the assessment device of the system of FIG. 1;

FIG. 3 is a block diagram of the functional modules of a software application running on the assessment device of FIG. 2;

FIG. 4 is a flowchart of a method for generating a computerized educational tool displayed on a graphical user interface;

FIG. 5 is a diagram showing modification of provider questions and recipient questions;

FIG. 6 is a schematic diagram of decision table mapping;

FIG. 7 is a diagram of a decision table;

FIG. 8 is a flowchart of a method for structuring a transaction using a decision table displayed on a graphical user interface; and

FIG. 9 is a schematic diagram of a system for generating a computerized educational tool, according to another non-limiting embodiment.

### DETAILED DESCRIPTION

The present disclosure relates to a computerized educational tool, and in particular, to a system and method for generating a computerized educational tool displayed on a graphical user interface. The computerized educational tool includes a computer-generated decision table which incorporates input variables having a non-linear relationship to decision-making.

In some applications, as described below, the decision table can be used for evaluating the probability that a particular transaction will fail. In such applications, the decision table can be generated in a manner mapping the non-linear impact of input variables on the probability that the transaction will fail to the cells of the decision table. The non-linear effects of such variables can be conveyed to a user by the examination of adjacent cells in the decision table.

Two parties participating in a transaction, the parties generally referred to as a provider and a receiver, can input data into a system for generating a computerized educational tool. The system can generate criteria relating to probability of failure of the transaction based on the input data, and can map the criteria to the decision table such that adjacency of cells in the decision table conveys meaningful contextual information. The system can indicate an appropriate position for the provider and receiver on the decision table according to the input data.

The decision table can be re-used by the same parties for re-evaluating the transaction at a later time, or by other parties evaluating a similar transaction, as an efficient means of evaluating the transaction without excessive reliance on computing power.

Other features and advantages of the system are described more fully below, where non-limiting embodiments of the system are described with reference to the following Figures.

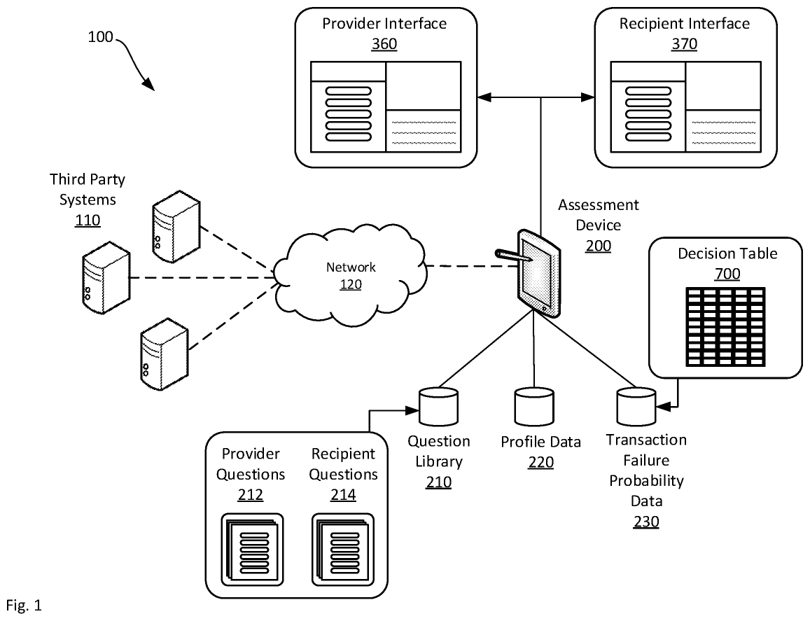

FIG. 1 is a schematic diagram of a system 100 for generating a computerized educational tool, according to a non-limiting embodiment. System 100 includes an assessment device 200 and third party systems 110, in communication over one or more computer networks, indicated as network 120. In this non-limiting embodiment, two participants considering a transaction, termed a provider and a receiver, use the assessment device 200 by inputting answers to questions into the assessment device 200 via provider user interface 360 and recipient user interface 370. The responses to the questions are used to generate a decision table 700 regarding the probability of failure of the transaction to aid in the participants' decision-making.

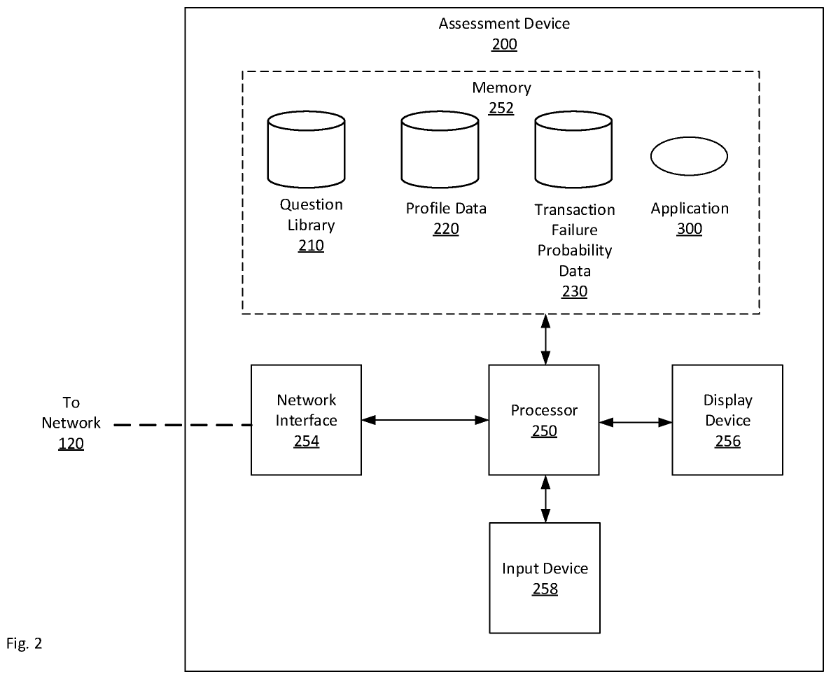

The third party systems 110 include a computing device running a user or server application with storage, communication, and processing means. The assessment device 200 includes a computing device running a user or server application with storage, communication, and processing means, discussed in greater detail below in FIG. 2.

The network 120 can include the internet, a Wi-Fi network, a local-area network, a wide-area network (WAN), a wireless cellular data network, a virtual private network (VPN), a combination of such, and similar.

Assessment device 200 stores a question library 210 comprising provider questions 212 and recipient questions 214. Assessment device 200 further stores profile data 220, which includes preliminary data about the provider and the recipient which may be relevant to the transaction being evaluated. Assessment device 200 further stores transaction failure probability data 230, which includes data used to generate the decision table 700, which may include responses to the provider questions 212 and recipient questions 214. The question library 210, profile data 220, and transaction failure probability data 230 may be stored in the same or separate data stores, such as a relational database, file system, and similar, and may be stored in separate locations (e.g. across separate devices) at the same location, on the assessment device 200.

Third party systems 110 include supplementary information provider devices which can provide supplementary data relevant to the provider, the recipient, or to the transaction being evaluated, for inclusion into generation of the decision table 700, or for structuring a transaction between the provider and recipient. Third party systems 110 also include transaction-facilitator systems which provides technical infrastructure for facilitating a transaction between provider and recipient, and can use profile data 220, transaction failure probability data 230, or decision table 700, to facilitate the transaction.

FIG. 2 is a block diagram of functional components of assessment device 200, according to a non-limiting embodiment. Assessment device 200 includes a processor 250, a memory 252, a network interface 254, a display device 256, and an input device 258.

Although a single processor 250 is shown, the term “processor” as discussed herein refers to any quantity and combination of a processor, a central processing unit (CPU), a microprocessor, a microcontroller, a field-programmable gate array (FPGA), and similar. The processor 250 is capable of processing large volumes of data and capable of processing data in a short period of time in a manner which enables the processing of algorithms having input variables having non-linear impacts on evaluation of a transaction.

The network interface includes programming logic enabling the assessment device 200 to communicate over network 120, is configured for bidirectional data communications through the network 120, and accordingly can include a network adaptor and driver suitable for the type of network

The memory 252 can include volatile storage and non-volatile storage. Volatile storage may include random-access memory (RAM) or similar. Non-volatile storage may include a hard drive, flash memory, and similar. The memory 252 stores the question library 210, profile data 220, and transaction failure probability data 230. The memory 252 further stores programming instructions for implementing application 300, and the functional modules thereof, described below.

The display device 256 includes a graphical display surface that can be configured to display provider user interface 360, recipient user interface 370, and decision table 700.

The input device 258 converts actions of a user into commands and data inputted into the assessment device 200. An input device 258 can include a keyboard, a mouse, or other pointing device. The input device 258 may be coupled with the display device 256 as a touch screen interface.

In some embodiments, assessment device 200 may include a smart phone running an operating system such as, for example, Android®, iOS®, Windows® mobile, BB 10, or similar. In other embodiments, the assessment device 200 includes a tablet computer, a laptop, a desktop computer, a personal digital assistant (PDA), or similar.

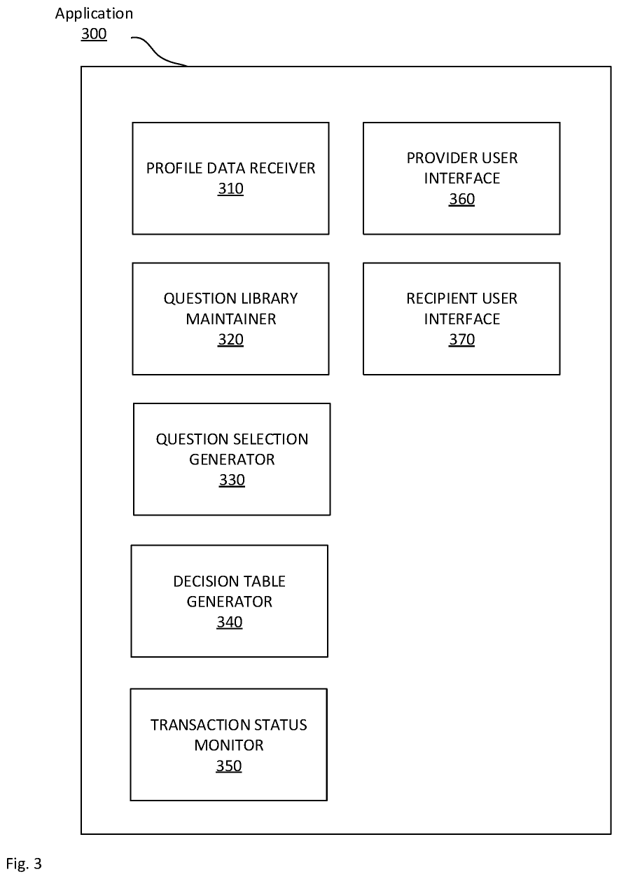

FIG. 3 is a block diagram of the functional modules of application 300, according to a non-limiting embodiment. The application 300 includes profile data receiver 310, question library maintainer 320, question selection generator 330, decision table generator 340, transaction status monitor 350, provider user interface 360, and recipient user interface 370.

Profile data receiver 310 is a program comprising programming instructions for receiving data at the assessment device 200, by input from a user through input device 258, or by a third party system 110 via network 120.

Question library maintainer 320 is a program comprising programming instructions for maintaining question library 210, including provider questions 212 and recipient questions 214. The questions in question library 210 may be curated by subject matter experts having experience relevant to the transaction being evaluated.

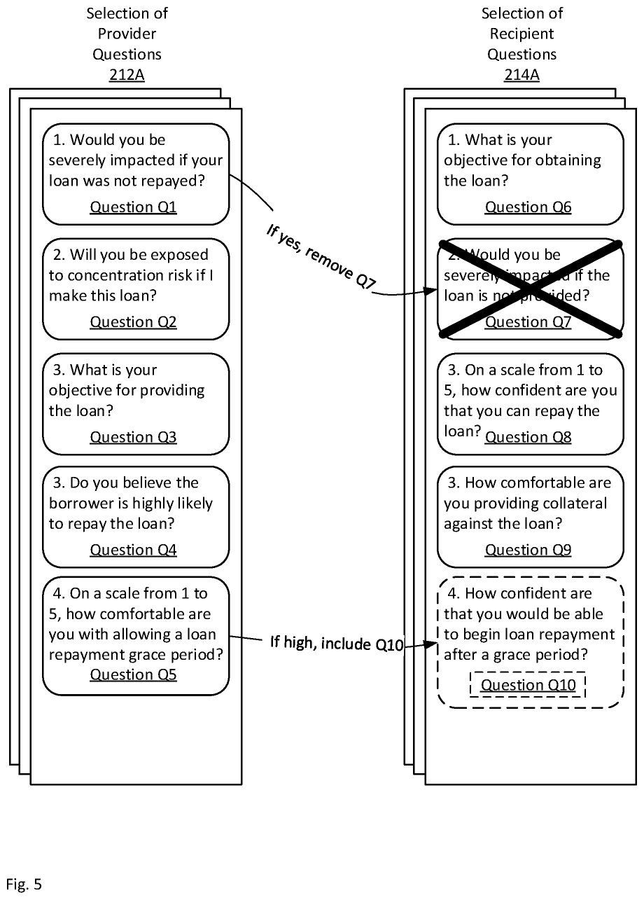

Question selection generator 330 is a program comprising programming instructions for generating a selection of provider questions to be presented to the provider and a selection of recipient questions to be presented to the recipient. The selection of provider questions may be presented to the provider via provider user interface 360. The selection of recipient questions may be provided to the recipient via the recipient user interface 370. The selections of questions are filtered from the provider questions 212 and recipient questions 214 and include questions most relevant to the provider and recipient based on profile data 220. Where one participant answers its selection of questions before the other participant, the second participant's questions may be tailored to the first participant's responses (see FIG. 5).

Decision table generator 340 is a program comprising programming instructions for generating a decision table 700. Generating a decision table 700 involves generating an ordered two-dimensional array of cells having a first dimension corresponding to the probability that the provider-recipient transaction will fail, from the perspective of risk to the provider, which may be referred to as the provider transaction failure probability. Similarly, the array of cells has a second dimension corresponding to the probability that the provider-recipient transaction will fail, from the perspective of risk to the recipient, which may be referred to as the recipient transaction failure probability.

In some embodiments, the provider transaction failure probability may refer to the risk that the transaction will result in an unfavorable outcome for the provider, and the recipient transaction failure probability may refer to the risk that the transaction will result in an unfavorable outcome for the recipient. In other words, the term probability may refer more generally to the likelihood of an occurrence, without being limited to the statistical meaning of the term probability as a statistic evaluated between the numbers 0 and 1. It is emphasized that these risks may be determined by qualitative algorithm, quantitative algorithm, or by a combination of qualitative algorithm and quantitative algorithm. The resulting risk assessment may include non-linear relationships between risks to the provider and risks to the recipient. For example, in some embodiments, according to one qualitative algorithm, some responses to provider questions 212, which are qualitative in nature, may have a differential impact on risk depending on responses to recipient questions 214, or vice versa. In some embodiments, some responses to provider questions 212 or recipient questions 214 may be weighed differently depending on responses to other provider questions 212 or recipient questions 214 during mapping of transaction risk criteria and/or provider & recipient transaction failure probability data to the decision table 700. Other provider transaction failure probability data or recipient transaction failure probability data may similarly be differentially weighed. These non-linear relationships can be conveyed in an easy to understand manner by mapping such risks and the participant's positions with respect to such risks on the decision table 700.

Each cell in the decision table 700 represents a particular context in which the provider is exposed to a certain degree of risk and the recipient is exposed to a certain degree of risk, associated with the coordinate of the cell in the decision table 700. Generating decision table 700 further involves mapping transaction failure probability criteria to the cells of the decision table 700, and indicating which cell corresponds to the provider-recipient transaction, as discussed in greater detail below.

The transaction status monitor 350 is a program comprising programming instructions for monitoring extrinsic variables which may impact the provider-recipient transaction, and enables the participants to reevaluate their position on the decision table 700 at a later time.

Provider user interface 360 is a user interface allowing input of preliminary provider data to be stored in profile data 220, receiving answers to questions posed to the provider to be stored in transaction failure probability data 230, and to view the decision table 700.

Recipient user interface 370 is analogous to provider user interface 360 for use by the recipient.

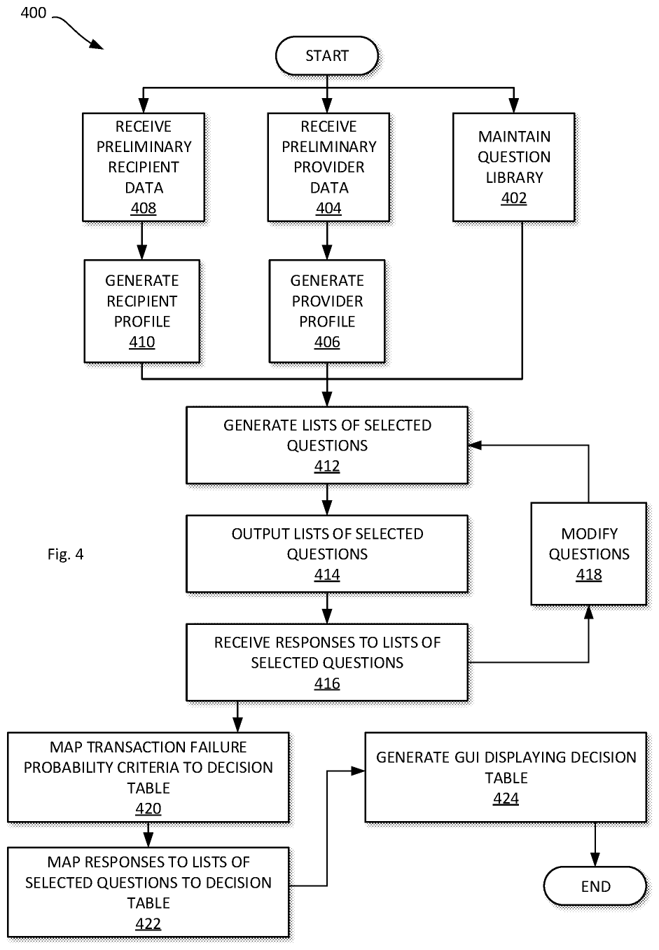

FIG. 4 is a flowchart showing a method 400 for generating a computerized educational tool displayed on a graphical user interface, according to a non-limiting embodiment. The computerized educational tool includes a computer-generated decision table. Briefly, the decision table is generating by gathering provider and recipient preliminary data, and posing questions and receiving responses to questions to the provider and recipient related to the probability that the transaction will fail, through the assessment device 200. It is to be emphasized, however, that the blocks of method 400 need not be performed in the exact sequence as shown. Further, the method 400 is described as performed by a system and device discussed herein, but this is not limiting and the method can alternatively be performed by other systems and/or devices.

At block 402, the question library 210 is maintained. The question library 210, including provider questions 212 and recipient questions 214, is stored in memory 252 on assessment device 200. The questions may be updated, removed, and new questions may be added to the question library 210, from time to time.

At block 404, preliminary provider data is received. Preliminary provider data provides background information about the provider which may be relevant to the provider-recipient transaction.

At block 406, the preliminary provider data is assembled into a provider profile.

At block 408, preliminary recipient data is received. Preliminary recipient data provides background information about the recipient which may be relevant to the provider-recipient transaction.

At block 410, the preliminary recipient data is assembled into a recipient profile.

At blocks 412 through 418, selected lists of provider questions and recipient questions are generated, outputted, and responses to the questions are received.

At block 412, a list of selected questions for the provider is generated from provider questions 212, and a list of selected questions for the recipient is generated from recipient questions 214.

In some embodiments, however, blocks 412 through 418 may be executed first for one of the participants, and second for the other participant, so that the selection of questions for the second participant can be curated based on the responses to the questions posed to the first participant.

Further, in some embodiments, blocks 412 through 418 may be iterative with respect to the same participant, where a next question is selected based at least in party on answers to a previous question. Hence, various paths of questioning can be traversed which may branch depending on particular answers.

Further still, in some embodiments, iteration of blocks 412 through 418 may trigger an exception which halts the method 400, for example where a threshold of probability of failure of the transaction, is reached. Where such a threshold is reached, the assessment device 200 may link the participant to helpful data or fetch data for presentation to the participant.

Further still, in some embodiments, questions may be ordered in terms of increasingly progressive disclosure, whereby a participant may choose to provide an amount of disclosure, and generate a decision table 700 accordingly, or may choose to proceed with additional questioning to generate a more nuanced decision table 700. Systems and methods for evaluating transactions via progressively disclosing data tokens are described in PCT/IB2017/057394, the entirety of which is incorporated herein by reference. Application of the systems and methods described therein to the present disclosure is contemplated.

At block 414, the selection of provider questions, the selection of recipient questions, or both, are outputted through provider user interface 360 or recipient user interface 370, as appropriate.

At block 416, responses to the selection of provider questions, the selection of recipient questions, or both, are received through provider user interface 360 or recipient user interface 370, as appropriate.

At block 418, the selection of questions for one participant may be modified based on the responses to the selection of questions for the second participant, and blocks 412 through 416 are executed for the second participant. An example of question modification is described in FIG. 5.

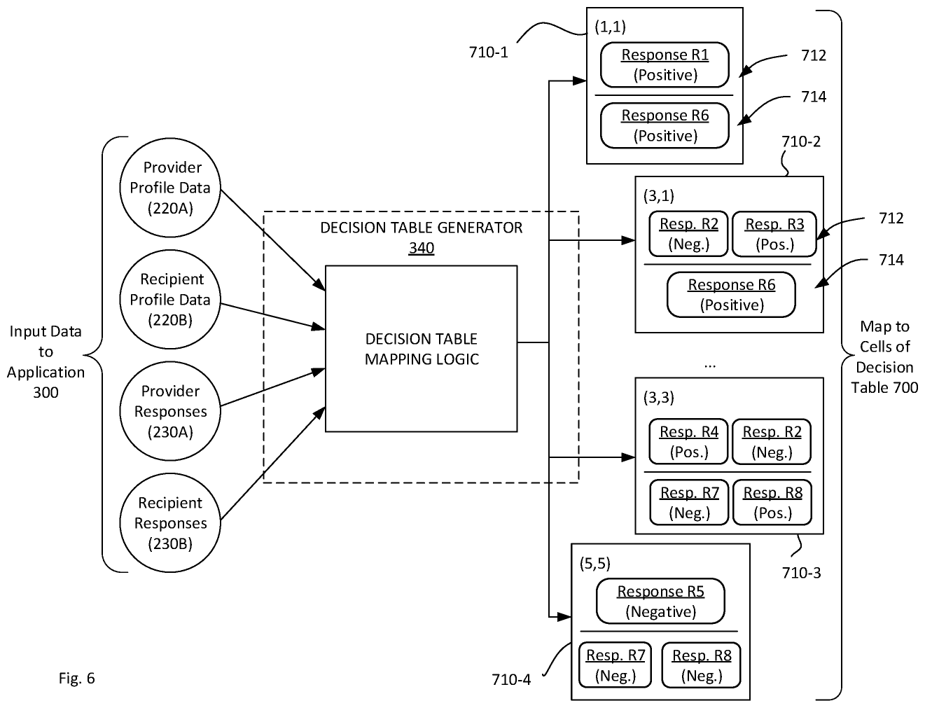

At block 420, transaction failure probability criteria are mapped to a decision table 700. In some embodiments, the transaction failure probability criteria comprises responses to the provider questions and the recipient questions. Thus, potential responses to provider and recipient questions can be mapped to cells of the decision table 700. Transaction failure probability criteria may be mapped to the decision table 700 at least in part by subject matter experts, including financial experts, psychological experts, sociological experts, or other experts, having experience relevant to the transaction being evaluated. However, the mapping of transaction failure probability criteria may also be dynamically mapped in response, at least in part, by profile data 220, and/or by transaction failure probability data 230, and generally by the algorithms discussed herein. The mapping may be non-linear, and may depend on profile data 220. Mapping of transaction failure probability criteria is discussed in greater detail at FIG. 6 below.

At block 422, responses to the provider questions and recipient questions, as stored in transaction failure probability data 230. Thus, the actual responses to provider and recipient questions can indicate a particular cell in the decision table 700 corresponding to the provider-recipient transaction.

At block 424, a graphical user interface displaying decision table 700 is generated, and outputted to the provider user interface 360, recipient user interface 370, or both. The decision table 700 can thus be used by the provider and recipient to evaluate the transaction, gauge risk that the transaction may fail, and structure the transaction accordingly. In some embodiments, the decision table 700 can be outputted in conjunction with text descriptions or graphical depictions, or other representations of the risk associated with the transaction, thus providing informational redundancy to the participant.

FIG. 5 is a diagram showing modification of provider questions and recipient questions, according to a non-limiting embodiment. In the present example, the transaction involves the provider lending to the recipient. In embodiments in which a first participant responds to questions before a second participant responds to questions, the selection of questions for the second participant can be curated based on the responses to the questions posed to the first participant. For example, if provider responds positively to Question Q1 (from selection of provider questions 212A), the selection of recipient questions 214A may be modified to remove Question Q7. Similarly, if and only if provider responds negatively to Question Q5, the selection of recipient questions may be modified to add Question Q10. Thus, the mapping of actual responses to the decision table 700 is informed by logic in which the transaction failure probability data is self-modifying in a non-linear manner.

FIG. 6 is a schematic diagram of decision table mapping, according to a non-limiting embodiment. As discussed above, the decision table can be generated in a manner mapping the non-linear impact of input variables on the probability that the transaction will fail to the cells of the decision table.

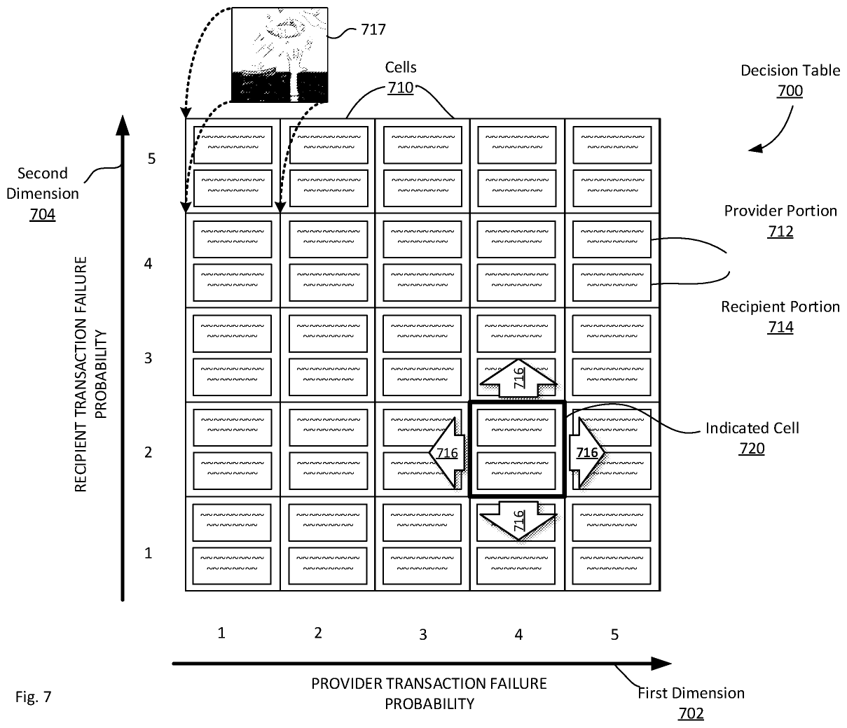

FIG. 7 is a diagram of a decision table 700, according to a non-limiting embodiment. Decision table 700 comprises a two-dimensional array of cells 710, arranged across a first dimension 702 corresponding to provider transaction failure probability and a second dimension 704 corresponding to recipient transaction failure probability. The cells 710 are situated at discrete coordinates defined by the dimensions 702, 704, shown here as a being scaled to gradations from 1 to 5. The arrangement of the first dimension as horizontal, and as pertaining to the provider, and the second dimension as vertical, and as pertaining to the recipient, and the scale being from 1 to 5, are exemplary only.

Provider portions 712 and recipient portions 714 of cells 710 provide indications of provider transaction failure probability and recipient transaction failure probability, respectively, which is described in greater detail below.

An indicated cell 720 is boldened to indicate that the coordinate occupied by indicated cell 720 corresponds to the provider-recipient transaction.

The cells 710 of the decision table 700 include indications of transaction failure probability, which may be in the form of text, graphics, or a combination of such. The cells can therefore include a written description of different scenarios, explaining the emotional states of the provider and recipient, as well as elements of the probability that the transaction will fail or the riskiness of the transaction. In some embodiments, graphical illustrations can be provided to convey similar information. For example, a cell 710 at coordinate (1,5) on the decision table 700, may display a graphical illustration 717 conveying the nature of the transaction. The graphical illustration 717 may be used in place a of a written description, or in combination with a written description.

In particular, the graphical illustration 717 conveys that the provider, who contributes little to overall transaction failure probability, is helping the recipient, who contributes highly to overall transaction failure probability. An example of such a graphical illustration may include an image of a person representing the provider throwing a lifesaver to a person representing the recipient, who is being helped by the transaction.

Returning to FIG. 6, and with continued reference to FIG. 7, generation of the decision table 700 is described. Inputs to the decision table mapping logic of the decision table generator 340 includes profile data 220, including provider profile data 220A and recipient profile data 220B. Inputs further include transaction failure probability data 230, including the provider's responses to the selection of provider questions 212A (termed provider responses 230A), and the recipient's responses to the selection of recipient questions 214A (termed recipient responses 230B).

In the example embodiment shown, the criteria for evaluating the probability that the transaction will fail comprises potential responses to questions 212A, 214A. Some potential responses, of both the provider and recipient, may indicate that the transaction is more likely to succeed, and other potential responses, of both the provider and recipient, may indicate that the transaction is more likely to fail. The potential responses can therefore be considered criteria for evaluating the probability that the transaction will fail (transaction failure probability criteria). The potential responses can be mapped to individual cells 710 in the decision table 700, so that each cell may be examined by a participant to understand how the potential responses position the participants on the decision table 700 with respect to the probability that the transaction will fail.

Each cell 710 may include both the provider's potential responses as an indication of provider transaction failure probability and the recipient's potential responses as an indication of recipient transaction failure probability. In either case, the transaction failure probability is represented by potential responses to the provider or recipient questions, and presented in the provider portion 712 or recipient portion 714, respectively. Several example cells 710-1, 710-2, 710-3, 710-4, are described.

For example, cell 710-1, which is mapped to coordinate (1,1) on the decision table 700, displays the positive version of the potential response to Question Q1 (Response R1 (Positive)), and displays the positive version of the potential response to Question Q6 (Response R6 (Positive)). In this example, a positive Response R1 (Positive) and positive Response Q6 (Positive) indicates that the transaction is not very likely to fail, and thus this indication of transaction failure probability is mapped to coordinate (1,1) on the decision table 700, the coordinate associated with the lowest possible transaction failure. The potential responses may be provided in text in the cell 710-1 in order to convey the contextual scenario associated with the lowest possible transaction failure.

As another example, a negative Response R2 (Negative), a positive Response R3 (Positive), and a positive Response R6 (Positive), are mapped to coordinate (3,1), which may indicate that the transaction is somewhat likely to fail. Furthermore, since the cell 710-2 is placed further on the first dimension (provider transaction failure probability) than the second dimension (recipient transaction failure probability), cell 710-2 conveys a contextual scenario in which the provider's circumstances, whether gleamed from provider profile data 220A or provider responses 230A (or any other data), are responsible for an increased likelihood of transaction failure. In other words, it is the provider who is bringing risk to the transaction. Thus, the participants using the decision table 700 may structure the provider-recipient transaction to account for the additional risk being taken by the recipient on account of the provider.

Cells 710-3 and 710-4 show additional examples of how different combinations of responses 230A, 230B, can impact transaction failure probability in a non-linear way, and how such contextual scenarios can be conveyed via the cells 710 of decision table 700. The cells may thereby include text descriptions of the emotional states of the provider and recipient, and elements relating to the riskiness of the transaction. In the present example, where the provider-recipient transaction is located near the bottom left of the decision table 700, the transaction is low-risk from the perspective of both provider and recipient. Where the transaction is located near the top right corner of the decision table 700, the transaction is risky for both parties.

An example of an indication of provider transaction failure probability follows, in the form of answers to provider questions: “I am totally comfortable with the loan. My goal is to help my child up the property ladder, giving them an easy way to source funds and/or keep the money in the family. I believe that the borrower will do whatever they can to make the repayments to me. □Even if they default, it will have a low impact on my day-to-day cashflow and not curb my lifestyle if I have to take over the repayments in the short term. In the worst case, and the loan can't be repaid in the longer term, it won't be a catastrophe; I don't have a high proportion of my assets tied up in the home loan. I'm likely to forgive the debt, rather than take legal action or sell the child's house. I feel I have a good understanding of the tax and legal issues.” The cells 710 may include other descriptions in the provider portions 712 thereof. Analogous written descriptions may be made from the recipient perspective, and included in recipient portions 714 of the cells 710.

The decision table mapping logic may include any kind of sorting, scaling, decision trees, and mapping algorithm, including various conditional logic. For example, a positive response to one question may be weighed more heavily than a negative response to the same questions. As another example, a negative response to one question may be weighed more heavily than positive responses to two other questions, but only where a fourth question is answered positively. Further, the weighing of responses may include cross-linking interaction, where a provider's response may impact the weight of a recipient's response, or vice versa. Algorithms can thereby be designed and tailored to the specific category of transaction the provider and recipient are considering engaging in.

Thus, the transaction failure probability criteria, which may be presented as potential responses to provider and recipient questions, is viewable from the decision table 700 to aid the participants in understanding the dynamics of a complex decision of whether to engage in a transaction, and where the participants stand with respect to the risks associated with engaging in the transaction. The participants may note the indicated cell 720 and reflect on whether the transaction failure probability criteria accurately reflects the scenario as understood by the participants, or may identify a more accurate coordinate by examining the cells 710 which are adjacent to the indicated cell 720 (indicated by adjacency arrows 716). Further, examination of the adjacent cells and the potential responses therein may reveal to the participants precisely how precarious the provider-recipient transaction is, and how the transaction may tend further toward probability of failure, should one or some of the provider or recipient questions be answered differently. Thus, a complex, non-linear relationship of input data to transaction failure probability can be conveyed in a manner easy to understand.

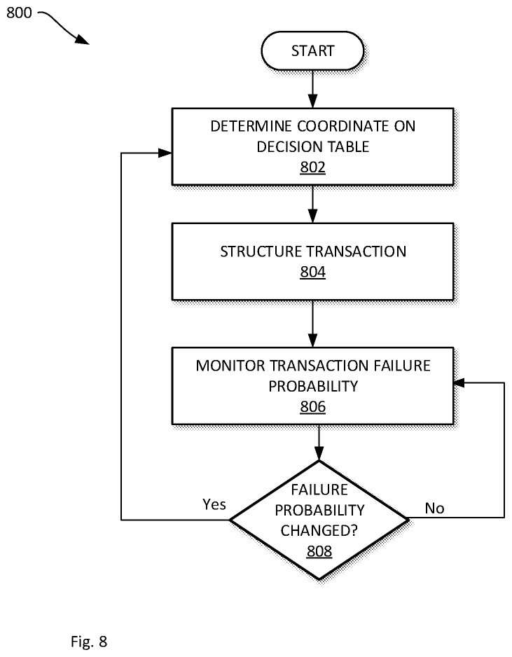

FIG. 8 is a flowchart showing a method 800 for structuring a transaction using a decision table displayed on a graphical user interface, according to a non-limiting embodiment. The computerized educational tool includes a computer-generated decision table, such as the decision table 700. Briefly, the participants determine their placement on a decision table 700, and may structure a transaction accordingly. Further, the participants' placement on the decision table 700 may be periodically reevaluated, and the transaction adjusted, if appropriate. It is to be emphasized, however, that the blocks of method 800 need not be performed in the exact sequence as shown. Further, the method 800 is described as performed by a system and device discussed herein, but this is not limiting and the method can alternatively be performed by other systems and/or devices.

At block 802, a coordinate on a decision table 700 is determined as being representative of a provider-recipient transaction.

At block 804, the provider-recipient transaction is structured. The decision table 700, and the coordinate determined as being representative of the transaction, may factor into the structure of the transaction. Further, additional information and facilitation of the transaction may be obtained by third party systems 110.

At block 806, the probability that the transaction may fail is monitored. External variables impacting the transaction, which may be obtained from third party systems 110 or from the provider or recipient, are gathered.

At block 808, it is determined whether the probability that the transaction will fail has changed. Where changed, the participants may determine a revised coordinate on decision table 700, at block 802, which more accurately reflects the provider-recipient transaction given the updated information. Where not changed, the probability that the transaction may fail is continued to be monitored at block 806.

Blocks 806 and 804 may proceed automatically in cooperation with a third party system 110. A third party system 110 can be configured to monitor the external variables impacting the transaction, and notify the participants where re-evaluation of the transaction is warranted.

Thus, the decision table 700 may be re-used by the participants as an education tool without the need to re-compute the mapping of transaction failure probabilities.

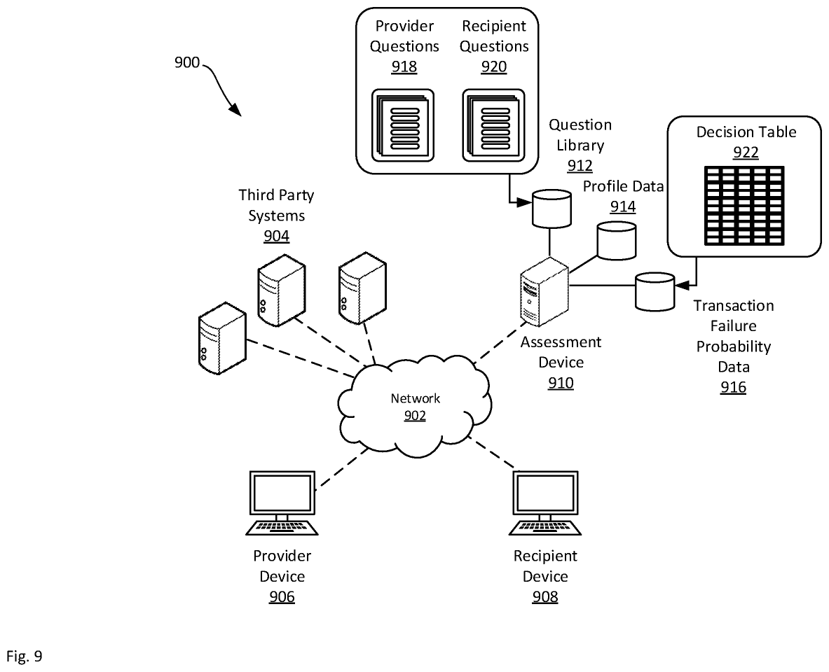

Variations to the system 100 are contemplated. For example, the assessment of transaction failure probability, including the gathering of data and generation of decision table, may take place across two or more devices, rather than on the assessment device 200 itself, such as in the example shown in FIG. 9.

FIG. 9 is a schematic diagram of a system 900 for generating a computerized educational tool, according to another a non-limiting embodiment. System 900 includes an assessment device 910 and third party systems 904, in communication over one or more computer networks, indicated as network 902. In this non-limiting embodiment, two participants considering a transaction, termed a provider and a receiver, use a provider device 906 and recipient device 908, respectively, to input data, and to transmit the data to the assessment device 910 to generate a decision table 922.

For description of third party systems 904, question library 912, provider questions 918, recipient questions 920, transaction failure probability data 916, and decision table 922, reference may be had to analogous components of system 100.

Provider device 906 and recipient device 908 each include a computer device running a user application with storage, communication, and processing means.

The assessment device 910 includes a computing device running a server application with a storage device, communication device, and processor. Although a assessment device 910 is described, it is understood that assessment device 910 may refer to a combination of servers, such as in a cloud computing environment.

The assessment device 910 stores a question library 912 containing provider questions 918 and recipient questions 920, profile data 914, and transaction failure probability data 916. The assessment device 910 can generate a decision table 922 in a manner analogous to that described in method 400 in FIG. 4, with the difference that preliminary provider and recipient data, and responses to provider questions 918 and recipient questions 920, is inputted via provider device 906 and recipient device 908, respectively, and transmitted to assessment device 910 for processing, and that the decision table 922 is displayed in a graphical user interface at the provider device 906, the recipient device 908, or both.

In some applications, the provider-recipient transaction may be a financial transaction, such as a loan from the provider to the recipient. In particular, the provider-recipient transaction may be an intergenerational loan between family members. However, other financial transactions are contemplated. Thus, in the following description of the application to intergenerational loans, reference may be had to the preceding Figures and the components thereof. However, it is to be understood that the preceding Figures and the components thereof are equally applicable to other applications outside of intergenerational loans, including other financial arrangements, non-financial arrangements such as in negotiating an employment agreement, selecting a career choice, comparing products, etc.

Lending between family members is commonplace. For example, as real estate prices increase, more home buyers are turning to family to help finance the purchase of a home. However, the risks of intergenerational lending may not be fully understood by lender and borrower. Thus, a computerized educational tool, such as a decision table of the type described herein, may educate the provider, i.e., the lender, and the recipient, i.e., the borrower, with respect to the probability that the transaction will fail, and the risk contributed by the lender and borrower. Further, and directing attention toward FIG. 1, a third party system 110 may include a financial institution which can facilitate the lender-borrower transaction, where the facilitation may be expedited by consultation with the decision table 700. A third party system 110 may also include a supplementary information provider device for providing additional information, including financial information, such as a participant's credit score, for inclusion in the provider transaction failure probability data or the recipient transaction failure probability data.

The profile data 220 may include a lender profile and a borrower profile. A lender profile may include financial data of the lender and an indication of an effect of non-payment of the loan by the borrower. A borrower profile may include data indicating a value of an asset, which may be an asset whose purchase is facilitated by the loan, a collateral asset owned by the borrower or lender (e.g., the lender's home), or similar, and data indicating a credit position of the borrower. A profile may store data indicative of the relationship between the borrower and the lender. Other data that may be stored by profiles are discussed elsewhere herein.

In some embodiments, the question library 210 includes questions related to intergenerational lending, such as questions related to expectations of borrowers and lenders, risk tolerance, potential reactions to various outcomes, such as default on the loan, and similar. Intergenerational lending is becoming an increasingly important means by which newer generations are able to afford expensive assets such as homes in economies where the price of real estate is increasing more quickly than wages. The decision table 700 described herein may therefore be used as an educational tool by a parent considering making a financial loan to a child, or for participants evaluating other similar intergenerational transactions. These questions may be curated by subject matter experts, including financial experts, psychological experts, sociological experts, or other experts, having experience relevant to the transaction being evaluated. Questions may be stored in plain English as opposed to financial terms. Questions may be directed to an underlying directive of protecting the asset, such as the home, and protecting the relationship between borrower and lender. Numerous types and examples of questions are discussed elsewhere herein.

In the application of assessing an intergenerational loan between a parent and a child, some of the questions may relate to the objective of the parent. For example, a question may relate to the reason for lending, and may present the lender with the following options for the reason for lending: investing in future generations (altruism); desire to remove the hassle of the borrower seeking a loan from a third party; making the loan affordable to the borrower; the borrower cannot obtain the loan elsewhere; helping the child build a credit history; obtaining a better rate of return for the lender; retaining money within the family; assisting with tax management; or assisting with wealth transfer. As an example of how the objective of a parent could cause other questions to be weighed differently, consider an example where the objective of the parent is altruistic. Where the objective of the parent is altruistic, their decision to engage in the loan is less impacted by any financial considerations (and thus responses to questions relating to finances are weighed less heavily), and that only the parent can weigh the benefit to them for providing the loan, since the benefit to the parent is primarily emotional and just highly subjective.

Some of the questions may relate to the objective of the child. For example, a question may ask the reason for borrowing, and may present the borrower with the following options for the reason for borrowing: resolving an issue with an existing financier; serving as unsecured debt obligation; serving as personal loan; serving as student loan; serving as deposit for home purchase; serving as a loan for a home purchase; or improving credit score.

Some of the questions may relate to the parents' exposure to financial risk by making the loan. For example, a question may ask that the parent describe on a scale from 1 to 5 Likert scale how comfortable they are financially with making the loan.

As another example, a question may ask about the parent's short term financial resiliency: “Can I afford to take over the loan repayments if my child can't make them?” A question may ask about the parent's long term financial resiliency: “Will I expose myself to concentration risk by having a high proportion of income-producing assets tied up in one investment?”, and similarly require an answer from 1 to 5 on a Likert scale.

Additional questions relating to the worst case financial scenario for the parent, whether the proposed loan amount is too great for the parent to manage, whether the parent believes the borrower will have a strong propensity to repay the loan. Additional questions may be posed which attempt to discern whether the parent is in a place of social vulnerability where they may be inclined to agree to provide a loan that is against their financial interest.

Analogous questions may be asked to the child, including the child's requirement for a deposit, the child's repayment capacity, and financial resilience.

Some of the questions may relate to the structuring of the loan, including the preferred interest rate, term, payment schedule, how any conflict would be resolved, whether payments may be ramped up in exchange for lower payments early in the payment term, how much involvement is required to maintain the investment, what recourse may be had (e.g. for the parent to force the child to sell the house for which the loan was provided), the applicability of any tax or legal rules, insurance, reporting, and auto-scheduling of payments.

Where real estate is being purchased by the child, questions may involve the real estate security—equity ratio, and the ease of selling the real estate.

As discussed above, various paths of questioning can be traversed which may branch depending on particular answers. For example, a question which may serve as critical path questions include whether the child has up any collateral against the loan.

Where collateral exists, questions may be posed abut the real estate security—equity ratio. Another critical path may include whether the parent is financially resilient. If not, additional questions may be asked about the structure of the loan and resolving defaulting of the loan.

Some of these questions may be posed to the parent, the child, or both. Any of the above responses can be contributed to transaction failure probability data 230, and combined with profile data 220, in the manner set out by the decision table generator 340.

The provider user interface 360 and recipient user interface 370 may include various tools for answering the questions posed, such as calculator tools, digital home loan valuation tools, credit score reports, comparison sites, and tax and legal information. Credit score reports and other supplementary data may be received from third party systems 110.

The transaction failure probability data 230 includes qualitative indications of risk specifically configured for intergenerational loans. Such indications may include text descriptors in plain English, which may omit financial language. The transaction failure probability data 230 may define, in effect, potential answers to the questions contained in the question library 210, as well as risks associated with such potential answers.

Turning attention to FIG. 6, the decision table mapping logic in the decision table generator 340 includes instructions to map profile data 220 to the question library 210 to obtain a subset of questions relevant to the specific lender and borrower. The assessment device 200 further includes instructions to map answers to the relevant questions to the transaction failure probability data 230 to output an assessment of the loan scenario for education and consideration by the specific lender and borrower. The assessment may include a personalized risk assessment for the lender and/or the borrower. The instructions may implement an artificial intelligence technique, such as machine learning, a neural network, pattern recognition, and similar. One or more qualitative algorithms may be used. In one example, a qualitative algorithm selects a series of questions and answering each question yields an element of an assessment. For instance, for the question (e.g., “How would you feel if your child missed a payment on the loan?”) each answer (e.g., “Okay”, “Terrible”) would yield a corresponding element of assessment (e.g., “Low risk”, “High risk”). In another example, a qualitative algorithm maps questions and potential answers to one or more elements of the assessment using a combination of logic that need not be bound by the order in which the questions are presented.

Provider profile data 220A may include data about the lender, such as risk tolerance and other information as discussed elsewhere herein. Turning attention to FIG. 4, the provider profile generated at block 406 of method 400 may accord to a common profile format for lenders.

Recipient profile data 220B may include data about the borrower, such as income and other information as discussed elsewhere herein. Again, with attention to FIG. 4, the recipient profile generated at block 410 of method 400 may accord to a common profile format for borrowers, which may be different from common profile format for lenders.

Preliminary data received at blocks 404 and 408 may also include data concerning the relationship between the borrower and lender for insertion into the relevant profiles. Relationship data may be qualitative and may indicate an amount of risk that the relationship can withstand. For example, some relationships may not be affected by a missed payment on the loan, whereas other relationships may suffer damage from a missed payment. Qualitative data may be provided using a scale, such as a ladder scale, a Likert scale, a selection from a list or dropdown, or similar.

Once all required data is available for a particular lending scenario, the lender profile and the borrower profile relevant to that scenario may be applied to the library of questions to obtain a selection of relevant questions, at block 412. The selection, or subset, of relevant questions are those questions that are most relevant to the specific lender and borrower. As different lenders and borrowers may have very different profiles, block 412 may result in very different subsets of relevant questions for different sets of lenders and borrowers.

Generating the selection of relevant questions may be triggered by both the lender and the borrower indicating to the system that their data has been entered. The system may check that lender and borrower profiles contain sufficient data to perform block 412. Applying profile data to the library of questions to obtain the subset of relevant questions may include applying an artificial intelligence technique, such as machine learning, a neural network, pattern recognition, and similar. One or more qualitative algorithms may be used.

At block 414, one or more questions are outputted to one or both of the lender and the borrower, via provider user interface 360 and recipient user interface 370. A question may be tagged for answer by the lender, borrow, or both users. As such, each question of the subset of relevant questions may be posed to the relevant party. This may include transmitting the question to the relevant lender and/or borrower computer across a computer network.

At block 416, an answer to a question is received. A user may indicate an answer using any type of user interface component, such as a button, checkbox, dropdown list, and similar. Block 416 may include receiving the answer from the relevant lender and/or borrower computer across a computer network.

Questions may be outputted all at once, serially one at a time, serially in groups of one or more questions. Not all questions need be answered.

At block 420, the transaction failure probability criteria, which may include potential responses to questions, is mapped to a decision table 700 in the manner described above.

At block 422, once all responses have been received, a decision table 700 is generated, based on the answers received. The assessment may be generated by applying answers to transaction failure probability data 230, which may include applying an artificial intelligence technique, such as machine learning, a neural network, pattern recognition, and similar. One or more qualitative algorithms may be used. The assessment may include a personalized risk assessment for the lender and/or the borrower. The cells 710 of the decision table 700 include indications of transaction failure probability, which may be in the form of text, graphics, or a combination of such. The cells can therefore include a written description of different scenarios, explaining the emotional states of the provider and recipient, as well as elements of the riskiness of the transaction. In some embodiments, graphical illustrations can be provided to convey similar information. For example, a cell 710 at coordinate (1,5) on the decision table 700, may display a graphical illustration 717 conveying the nature of the transaction. In particular, the graphical illustration 717 may convey that the provider, who contributes little to overall transaction failure probability, is helping the recipient, who contributes highly to overall transaction failure probability. An example of such a graphical illustration may include an image of a person representing the provider throwing a lifesaver to a person representing the recipient, who is metaphorically drowning under financial burdens.

Directing attention to FIG. 8, after a coordinate on a decision table 700 is determined at block 802, a transaction may be structured by the participants at block 804. Structuring the transaction may include the assessment device 200 computing an interest rate for the loan, determining a risk for a particular structure of the loan, determining a link (e.g., a web hyperlink) to a service or service provider, of the third party systems 110, for facilitating the loan, applying a ladder scale, computing one or more single-dimension risks associated with the loan, and/or determining a text descriptor for a risk associated with the loan. The interest rate may be determined based on the mid-point between commercial rates of borrowing and saving, or may be determined algorithmically based on the transaction failure probability data 230. The assessment device may also generate, output, or link to a service or service provider for, documentation for the loan, displaying options for documenting the loan, displaying options for obtaining an assessment be performed on the house, etc. The assessment device may also generate or output an action plan, including possibly executing and registering the appropriate legal documents documenting the loan, establishing relationships with financial institutions to facilitate the loan, seeking independent legal advice, engaging a third party service to monitor extrinsic variables impacting the loan, etc.

Feedback may be received from the lender and/or borrower and such feedback may be incorporated into the method 400, to improve the questions and assessments provided during subsequent executions of the method.

Thus, it can be seen that a computerized education tool in the form of a decision table can aid in decision-making involving complex, non-linear problems. A decision table can convey non-linear relationships in a contextual manner through visual adjacency of cells in the decision table. Participants evaluating a transaction, including a financial transaction such as an intergenerational loan, can gain greater contextual understanding of the risks involved in such a transaction.

Further, the tool can be used as an efficient means of conveying transaction failure probability to third parties without the need for reproduction of computationally intensive calculation.

While the implementations discussed herein are directed to specific implementations of the system, it will be understood that combinations, sub-sets, and variations of the implementations are within the scope of the present disclosure.

The scope of the claims should not be limited by the embodiments set forth in the above examples, but should be given the broadest interpretation consistent with the description as a whole.

1. A graphical user interface system comprising:
a provider user interface;
a recipient user interface;
a memory for storing programming instructions; and
a processor in communication with the memory and configured to execute the programming instructions to:
generate a decision table comprising an ordered two-dimensional array of cells, the decision table having a first dimension corresponding to provider transaction failure probability and a second dimension corresponding to recipient transaction failure probability, a cell providing indications of provider transaction failure probability and recipient transaction failure probability corresponding to a coordinate of the cell in the two dimensions;
receive provider transaction failure probability data from the provider user interface and recipient transaction failure probability data from the recipient user interface;
map transaction failure probability criteria to the cells of the decision table according to a qualitative algorithm;
map the provider transaction failure probability data, and the recipient transaction failure probability data to the decision table to indicate a cell of the decision table corresponding to the provider transaction failure probability data and the recipient transaction failure probability data; and
generate a graphical user interface displaying the decision table for output at the provider user interface, the recipient user interface, or both the provider user interface and the recipient user interface.

2. The system of claim 1, wherein the qualitative algorithm involves weighing a portion of the provider transaction failure probability data or the recipient transaction failure probability data differently according to a non-linear relationship between provider transaction failure probability and recipient transaction failure probability.

3. The system of claim 1, wherein the processor is further configured to execute the programming instructions to:
receive preliminary provider data and preliminary recipient data;
maintain a provider question library comprising questions relating to the provider transaction failure probability data, and maintain a recipient question library comprising questions relating to the recipient transaction failure probability data; and
generate a selection of provider questions from the provider question library based on the preliminary provider data, the preliminary recipient data, or both the preliminary provider data and the preliminary recipient data;
output the selection of provider questions and receive responses to the selection of provider questions via the provider user interface, the provider transaction failure probability data corresponding to the responses to the selection of provider questions;
generate a selection of recipient questions from the recipient question library based on the preliminary provider data, the preliminary recipient data, or both the preliminary provider data and the preliminary recipient data; and
output the selection of recipient questions and receive responses to the selection of recipient questions via the recipient user interface, the recipient transaction failure probability data corresponding to the responses to the selection of recipient questions.

4. The system of claim 3, wherein:
the qualitative algorithm involves weighing a response of the responses to the selection of provider questions or the responses to the selection of recipient questions differently based on another response of the responses to the selection of provider questions or the responses to the selection of recipient questions.

5. The system of claim 3, wherein the processor is further configured to execute the programming instructions to modify the selection of provider questions or the selection of recipient questions according to a response to the selection of provider questions or the selection of recipient questions.

6. The system of claim 3, wherein an indication of provider transaction failure probability or recipient transaction failure probability comprises a written description response to a question of the selection of provider questions or the selection of recipient questions.

7. The system of claim 3, wherein an indication of provider transaction failure probability or recipient transaction failure probability, or both, comprises a graphical illustration.

8. The system of claim 1, wherein the system further comprises a computer network, a network interface in communication with the processor, and a transaction mediator device in communication with the network interface via the computer network, the transaction mediator device being configured to facilitate a transaction based on at least the provider transaction failure probability data and the recipient transaction failure probability data.

9. The system of claim 1, wherein the system further comprises a computer network, a network interface in communication with the processor, and a supplementary information provider device in communication with the network interface via the computer network to provide supplementary data for inclusion in the provider transaction failure probability data or the recipient transaction failure probability data.

10. The system of claim 1, wherein the system further comprises an assessment device having the memory and the processor, and the assessment device is configured to display the provider user interface, the recipient user interface, and the graphical user interface displaying the decision table.

11. The system of claim 1, wherein the system further comprises a computer network, a network interface in communication with the processor, a provider device and a recipient device both in communication with the network interface via the computer network, the provider device configured to display the provider user interface, the recipient device configured to display the recipient user interface.

12. A method for generating a graphical user interface displaying a decision table, the method comprising:
generating a decision table comprising an ordered two-dimensional array of cells, the decision table having a first dimension corresponding to provider transaction failure probability and a second dimension corresponding to recipient transaction failure probability, a cell providing indications of provider transaction failure probability and recipient transaction failure probability corresponding to a coordinate of the cell in the two dimensions;
receiving provider transaction failure probability data from a provider user interface and recipient transaction failure probability data from a recipient user interface;
mapping transaction failure probability criteria to the cells of the decision table according to a qualitative algorithm;
mapping the provider transaction failure probability data, and the recipient transaction failure probability data to the decision table to indicate a cell of the decision table corresponding to the provider transaction failure probability data and the recipient transaction failure probability data; and
generating a graphical user interface displaying the decision table for output at the provider user interface, the recipient user interface, or both the provider user interface and the recipient user interface.

13. The method of claim 12, wherein the qualitative algorithm involves weighing a portion of the provider transaction failure probability data or the recipient transaction failure probability data differently according to a non-linear relationship between provider transaction failure probability and recipient transaction failure probability.

14. The method of claim 12, wherein method further comprises:
receiving preliminary provider data and preliminary recipient data;
maintaining a provider question library comprising questions relating to the provider transaction failure probability data, and maintain a recipient question library comprising questions relating to the recipient transaction failure probability data; and
generating a selection of provider questions from the provider question library based on the preliminary provider data, the preliminary recipient data, or both the preliminary provider data and the preliminary recipient data;
outputting the selection of provider questions and receive responses to the selection of provider questions via the provider user interface, the provider transaction failure probability data corresponding to the responses to the selection of provider questions;
generating a selection of recipient questions from the recipient question library based on the preliminary provider data, the preliminary recipient data, or both the preliminary provider data and the preliminary recipient data; and
outputting the selection of recipient questions and receive responses to the selection of recipient questions via the recipient user interface, the recipient transaction failure probability data corresponding to the responses to the selection of recipient questions.

15. The method of claim 14, wherein:
the qualitative algorithm involves weighing a response of the responses to the selection of provider questions or the responses to the selection of recipient questions differently based on another response of the responses to the selection of provider questions or the responses to the selection of recipient questions.

16. The method of claim 14, wherein the method further comprises modifying the selection of provider questions or the selection of recipient questions according to a response to the selection of provider questions or the selection of recipient questions.

17. The method of claim 12, further comprising:
monitoring transaction failure probability;
updating provider transaction failure probability or recipient transaction failure probability; and
determining a revised coordinate corresponding to updated provider transaction failure probability or recipient transaction failure probability.

18. The method of claim 12, further comprising:
examining an indication of provider transaction failure probability and recipient transaction failure probability of cell adjacent to the cell corresponding to the provider transaction failure probability data and the recipient transaction failure probability data;
revising provider transaction failure probability or recipient transaction failure probability; and
determining a revised coordinate corresponding to revised provider transaction failure probability or recipient transaction failure probability.
